(19) United States
(12) Patent Application Publication
(10) Pub. No.: US 2019/0328153 A1
(43) Pub. Date: Oct. 31, 2019

(54) Shoulder strap for an infant car seat carrier

(71) Applicant: Sounsery Kayachith, Moreno Valley, CA (US)

(72) Inventor: Sounsery Kayachith, Moreno Valley, CA (US)

(21) Appl. No.: 15/965,939

(22) Filed: Apr. 29, 2018

(51) Int. Cl. A47D 13/02; B60N 2/28

(52) U.S. Cl. CPC A47D 13/025; B60N 2/2842

(57) ABSTRACT

The invention is directed to a shoulder strap for an infant car seat carrier. The strap provides a large shoulder pad near the upper end, to cushion the weight as it rests on the user's shoulder. The upper and lower ends of the strap terminate in large oval snap hooks. Each snap hook provides a screw nut on each side. One of the screw nuts can only be completely removed with a tool, and therefore operates as a hinge, such that the user may easily attach and remove the strap with one hand. A buckle near the center of the strap allows the user to adjust the length of the strap. In a second embodiment, the upper and lower ends of the strap terminate in inverted V-shaped straps, each of which provides two spring snap hooks which may be secured to the car seat frame on the side surface of the car seat carrier.

### CROSS-REFERENCE TO RELATED APPLICATIONS

This application relates back to, and claims the priority of Provisional Patent Application No. 62/492,231 filed on Apr. 30, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to infant care accessories, and in particular to a shoulder strap for an infant car seat carrier. Millions of parents in the United States and Canada use infant car seat carriers. These are car seats with a large central handle, which may be detached from a frame and used to carry the infant outside the car on short excursions, such as a grocery store or restaurant. Unfortunately, many parents lack the arm strength which is necessary to do this comfortably, and others may be temporarily unable to carry the infant in a car seat carrier due to an arm injury. The arm has some of the smallest, weakest muscles in the body. A device which can shift this load to larger, more powerful muscles would enable these parents to more easily carry the load, and would be very well received.

A search of the prior art reveals various devices which have been developed to provide the features of an apparatus which enables easier carrying of an infant in a car seat, which is inexpensive and capable of being removed and reattached quickly and easily. None are closely related to the present invention, but several include features which resemble those of the present invention. Each has proven to be less than satisfactory for the present purpose in its own way.

Carrying sling for infant carrier or car seat, U.S. Pat. No. 5,267,680 (priority Feb. 21, 1992), provides a carrying sling for an infant carrier or car seat is disclosed. The sling uses a strap held in the hand or across the shoulder from which the occupied carrier is suspended by means of multiple support straps. The support straps contain length adjustors and buckles which allow the sling to open for loading and unloading the carrier. The support straps are also provided with means of attachment to the carrier frame.

Method and apparatus for carrying a car seat, U.S. Patent Appl. No. 2003/0106916A1 (priority Dec. 7, 2001), provides an apparatus for carrying a car seat such as an infant car seat, child car seat, or a child booster seat is disclosed. The apparatus includes a carrier body and at least one system of harnesses for attaching to the car seat, and for securing the apparatus on a person's back, chest, or side, leaving the person's hands free. The system of harnesses may include an upper harness system, a middle harness system, a lower harness system, a shoulder harness system, and a hip harness system. The apparatus permits a person to carry the car seat together with a child secured in the car seat. (See also U.S. Patent Appl. No. 2003/0106916A1.)

Infant or child car seat carrying device, U.S. Patent Appl. No. 2004/0195283A1 (priority Apr. 1, 2003), provides a car seat carrying device is described that permits a user to carry an empty car seat on his or her back freeing his or her hands and arms to perform other tasks. One embodiment of the device includes left and right shoulder straps connected by a center section. The center section is typically threaded through slotted openings in the car seat. Slotted openings are generally provided in car seats to permit seat belts or LATCH straps to pass through them when securing a car seat in a vehicle.

Car seat transport device and method, U.S. Patent Appl. No. 2007/0080184A1 (priority Oct. 7, 2005), provides a compact, lightweight, foldable, easy to use, low cost, portable car seat transport device and method of using the same. The car seat transport device may be adapted to carry any type of car seat. The device includes a harness having a lower strap and an upper strap, each strap having respective first and second ends. The lower strap may be adapted to extend through a lower slot in the car seat and the upper strap may be adapted to extend through an upper slot of the car seat. The upper strap may be attached to the lower strap and the first and second ends of the lower strap may be attached to each other. The harness may be a single piece with the upper strap being fixedly attached to the lower strap. The car seat transport device provides a remarkably easy to use and effective support system that permits hands-free carriage of the car seat from a person's body.

Counter balancing car seat carry strap with dual lock mechanisms, U.S. Patent Appl. No. 2008/0245830A1 (priority Apr. 6, 2007), provides a carrying device for supporting a load, such as an infant car seat, on a person is disclosed. The device comprises a primary strap that has a first end and a second end. Each end terminates in one of two cooperating parts of a primary locking mechanism. A secondary strap has a first end and a second end. The first end of the secondary strap is fixed proximate the first end of the primary strap. A secondary, redundant locking mechanism has two cooperating parts. One part being fixed to the second end of the secondary strap and the other part being fixed proximate the second end of the primary strap.

The purpose of the present invention is to correct the deficiencies in the existing inventions cited herein, and thereby provide a substantial improvement over all the prior art. A shoulder strap for an infant car seat carrier, which redistributes the load to the powerful back and shoulder muscles, would resolve this problem.

### SUMMARY OF THE INVENTION

Accordingly, the invention is directed to a shoulder strap for an infant car seat carrier. The strap provides a large shoulder pad near the upper end, to cushion the weight as it rests on the user's shoulder. The upper and lower ends of the strap terminate in large oval snap hooks. Each snap hook provides a screw nut on each side. One of the screw nuts can only be completely removed with a tool, and therefore operates as a hinge, such that the user may easily attach and remove the strap with one hand. A buckle near the center of the strap allows the user to adjust the length of the strap. In a second embodiment, the upper and lower ends of the strap terminate in inverted V-shaped straps, each of which provides two spring snap hooks which may be secured to rings on the side surface of the car seat carrier.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate two embodiments of the invention and, together with the description, serve to explain the principles of the invention.

FIG. 1 is a diagonal front view of the first exemplary embodiment, displaying the strap 10, the snap hooks 11, the screw nuts 12, the shoulder pad 13, and the buckle 14.

FIG. 2 is a front view of the first exemplary embodiment, displaying the strap 10, the snap hooks 11, and the shoulder pad 13.

FIG. 3 is a side perspective view of the first exemplary embodiment secured to a car seat carrier, displaying the strap 10, the snap hook 11, the car seat carrier 15, and the handle 16.

FIG. 4 is a side perspective view of the first exemplary embodiment secured to a car seat carrier with the snap hooks inserted through apertures in the handle, displaying the strap 10, the snap hook 11, the car seat carrier 15, the handle 16, and the apertures 17.

FIG. 5 is a side perspective view of the second exemplary embodiment, displaying the strap 10, the car seat frame 10A, the V-shaped straps 10B, the spring snap hooks 10C, and the elastic bands 10D.

FIG. 6 is a front view of the second exemplary embodiment, displaying the strap 10, the car seat frame 10A, the V-shaped strap 10B, and the spring snap hooks 10C.

FIG. 7 is a side perspective view of the second exemplary embodiment secured to a car seat carrier, displaying the strap 10, the spring snap hooks 10C, the car seat carrier 15, and the car seat frame 18.

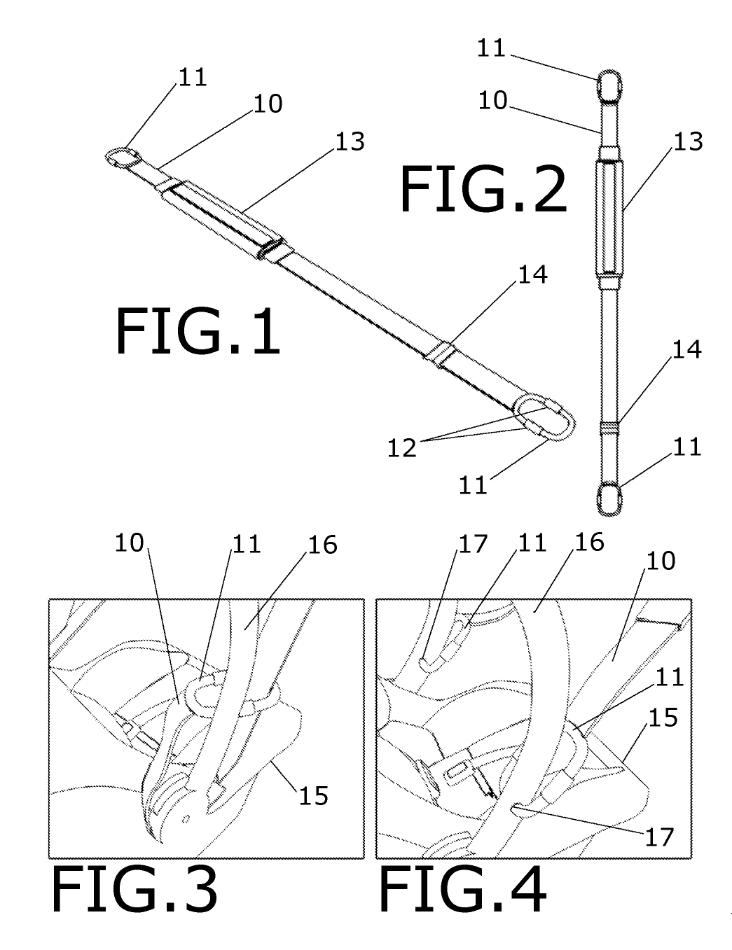

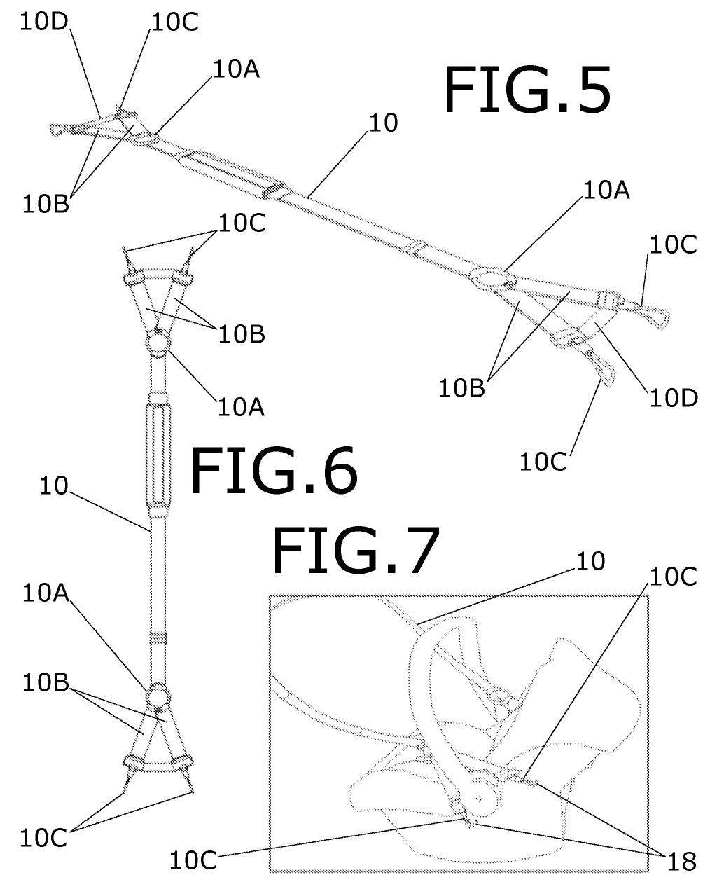

### DETAILED DESCRIPTION OF THE INVENTION

Referring now to the invention in more detail, the invention is directed to a shoulder strap 10 for an infant car seat carrier 15.

The first exemplary embodiment is comprised of a strap 10 which provides a large shoulder pad 13 near the upper end, to cushion the weight as the strap 10 rests on the user's shoulder. The upper and lower ends of the strap 10 terminate in large oval snap hooks 11. Each snap hook 11 provides a screw nut 12 on each side. One of the screw nuts 12 can only be completely removed with a tool, and therefore operates as a hinge, such that the user may easily attach and remove the strap 10 with one hand. A buckle 13 near the center of the strap 10 allows the user to adjust the length of the strap 10.

Ideally, the user wears the strap 10 over one shoulder, and the snap hooks 11 are inserted into circular apertures 17 which are drilled into each end of the handle 16, near the insertion points. Alternatively, the snap hooks 11 may be affixed at other points on the perimeter of the car seat carrier 15.

The second exemplary embodiment is similar in structure and function to the first exemplary embodiment, with the following modifications. Each snap hook 11 is replaced in the design by a car seat frame 10A, through which an inverted V-shaped strap 10B has been threaded. The two lower ends of the V-shaped strap 10B each terminate in spring snap hooks 10C, which may be secured to the car seat frame 18 provided on the side surfaces of the car seat carrier 15. The two lower ends of the V-shaped strap 10B may be separated by an elastic band 10D.

To use the first or the second exemplary embodiment, the user adjusts the length of the strap 10 by sliding the buckle 14 to the desired position, then bends over and positions the strap 10 such that the strap 10 lays diagonally across the user's back, with the shoulder pad 13 resting on one of the user's shoulders. The user then affixes the oval snap hooks 11 or the spring snap hooks 10C to the car seat carrier 15, and stands up with the car seat carrier 15 resting against the front of the user's torso.

The strap 10, the V-shaped straps 10B, and the shoulder pad 13 are preferably manufactured from a flexible, durable material with substantial tensile strength, such as nylon webbing. The car seat frame 10A, the spring snap hooks 10C, the snap hooks 11, the screw nuts 12, and the buckle 14 are preferably manufactured from rigid, durable materials with substantial structural strength, such as stainless steel, aluminum alloy, and brass. The elastic band 10D is preferably manufactured from a flexible, durable material with an elastic quality, such as elasticized cotton. Components and methods listed above are preferable, but artisans will recognize that alternate components and methods could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A shoulder strap for an infant car seat carrier, comprised of a strap which provides a large shoulder pad near the upper end, to cushion the weight as the strap rests on the user's shoulder.

2. The shoulder strap of claim 1, wherein the upper and lower ends of the strap terminate in large oval snap hooks, each of which providing a screw nut on each side.

3. The shoulder strap of claim 1, wherein one of the screw nuts on each snap hook can only be completely removed with a tool, and therefore operates as a hinge, such that the user may easily attach and remove the strap with one hand.

4. The shoulder strap of claim 1, wherein a buckle is provided near the center of the strap which allows the user to adjust the length of the strap.

5. The shoulder strap of claim 1, wherein ideally, the user wears the strap over one shoulder, and the snap hooks are inserted into circular apertures which are drilled into each end of the handle, near the insertion points.

6. The shoulder strap of claim 1, wherein alternatively, the snap hooks may be affixed at other points on the perimeter of the car seat carrier.

7. The shoulder strap of claim 1, wherein the user adjusts the length of the strap by sliding the buckle to the desired position, then bends over and positions the strap such that the strap lays diagonally across the user's back, with the shoulder pad resting on one of the user's shoulders.

8. The shoulder strap of claim 1, wherein the upper and lower ends of the strap terminate in spring snap hooks, which may be secured to a car seat frame which is provided.

9. The shoulder strap of claim 7, wherein the user may then affix the snap hooks to the car seat carrier, and stand up with the car seat carrier resting against the front of the user's torso.

10. The shoulder strap of claim 7, wherein the strap and the shoulder pad are preferably manufactured from a flexible, durable material with substantial tensile strength, such as nylon webbing.

11. The shoulder strap of claim 7, wherein the snap hooks, the screw nuts, and the buckle are preferably manufactured from rigid, durable materials with substantial structural strength, such as stainless steel, aluminum alloy, and brass.
